(19) United States
(12) Patent Application Publication
(10) Pub. No.: US 2026/0275684 A1
(43) Pub. Date: Sep. 17, 2026

(54) CONTROL SYSTEM FOR WORK MACHINE, WORK MACHINE, AND CONTROL METHOD FOR WORK MACHINE

(71) Applicant: KOMATSU LTD., Tokyo (JP)

(72) Inventors: Kentaro MURAKAMI, Minato-ku, Tokyo (JP); Hiromasa KITAMURA, Minato-ku, Tokyo (JP); Yoshihiro KUMAGAE, Minato-ku, Tokyo (JP); Yuta TANIGUCHI, Minato-ku, Tokyo (JP)

(73) Assignee: KOMATSU LTD., Tokyo (JP)

(21) Appl. No.: 19/115,257

(22) PCT Filed: Oct. 19, 2023
(86) PCT No.: PCT/JP2023/037816

§ 371 Date: Mar. 26, 2025

(30) Foreign Application Priority Data
Oct. 21, 2022 (JP) 2022-168957

(51) Int. Cl. E02F 9/20

(52) U.S. Cl. CPC E02F 9/2091

(57) ABSTRACT

A work machine control system includes a first controller configured to start shutdown processing on the basis of a key-off signal from a key switch, a second controller configured to start shutdown processing on the basis of the key-off signal, and a notification device configured to change from a first state to a second state in response to ending of the shutdown processing by the first controller. The first controller is configured to end the shutdown processing after determination that the second controller has ended the shutdown processing.

### TECHNICAL FIELD

The disclosure relates to a control system for a work machine, a work machine, and a control method for a work machine.

### BACKGROUND ART

A work machine includes a controller that operates using power supplied from a battery. Even in a case where the work machine is in a key-off state, when a stopped period of the work machine is prolonged, there is a possibility that the battery over-discharges (battery died) due to dark current flowing from the battery to the controller. The work machine is therefore provided with a cutoff switch for cutting off the power supply from the battery to the controller. In a case where the work machine is to be stopped for a long period of time, an operator operates the cutoff switch, causing the dark current to no longer flow from the battery to the controller. The dark current no longer flows from the battery to the controller, suppressing over-discharge of the battery.

There is a possibility that the cutoff switch is erroneously operated during operation of the controller. Upon operating the cutoff switch during operation of the controller, the power supply from the battery to the controller is forcibly cut off. When the power supply from the battery to the controller is forcibly cut off, there is a possibility that the controller abnormally terminates. When the controller abnormally terminates, the controller may fail. Patent Document 1 discloses a construction machine including a cutoff switch and a light-emitting diode (LED) interlocked with the controller. The LED is turned on during operation of the controller and turned off in response to the controller shutting down. The operator can recognize whether the controller is shut down by checking the LED. The operator does not operate the cutoff switch while the controller is in operation, but can operate the cutoff switch after the controller shuts down. Since the cutoff switch is suppressed to be operated during operation of the controller, failure of the controller is suppressed.

### CITATION LIST

### Patent Literature

Patent Document 1: JP 2011-063234 A.

### SUMMARY OF INVENTION

### Technical Problem

There are cases where a plurality of controllers are mounted on a work machine. For example, there are cases where a controller interlocked with an LED such as described above and a controller not interlocked with the LED are mounted. Even in cases where a controller interlocked with an LED and a controller not interlocked with an LED are mounted on a work machine, there is demand for technology that suppresses the forced cutoff of the power supply from the battery to the controllers during operation of the controllers.

An object of the disclosure is to suppress forced cutoff of a power supply from a battery to a controller during operation of the controller.

### Solution to Problem

According to the disclosure, provided is a control system for a work machine, the control system including a first controller configured to start shutdown processing on the basis of a key-off signal from a key switch, a second controller configured to start shutdown processing on the basis of the key-off signal, and a notification device configured to change from a first state to a second state in response to ending of the shutdown processing by the first controller. The first controller is configured to end the shutdown processing after determination that the second controller has ended the shutdown processing.

### Advantageous Effects of Invention

According to the disclosure, forced cutoff of a power supply from a battery to a controller during operation of the controller is suppressed.

### BRIEF DESCRIPTION OF DRAWINGS

FIG. 1 is a diagram schematically illustrating a work machine according to an embodiment.

FIG. 2 is a block diagram illustrating the work machine according to the embodiment.

FIG. 3 is a block diagram illustrating a control system for the work machine according to the embodiment.

FIG. 4 is a functional block diagram illustrating a processing circuit of a first controller according to the embodiment.

FIG. 5 is a flowchart illustrating a control method for the work machine according to the embodiment.

FIG. 6 is a diagram illustrating a control method for a work machine according to another embodiment.

### DESCRIPTION OF EMBODIMENTS

Hereinafter, embodiments of the disclosure will be described, but the disclosure is not limited to the embodiments. The components of the embodiments described below can be combined as appropriate. In addition, some components may not be used in some cases.

### Work Machine

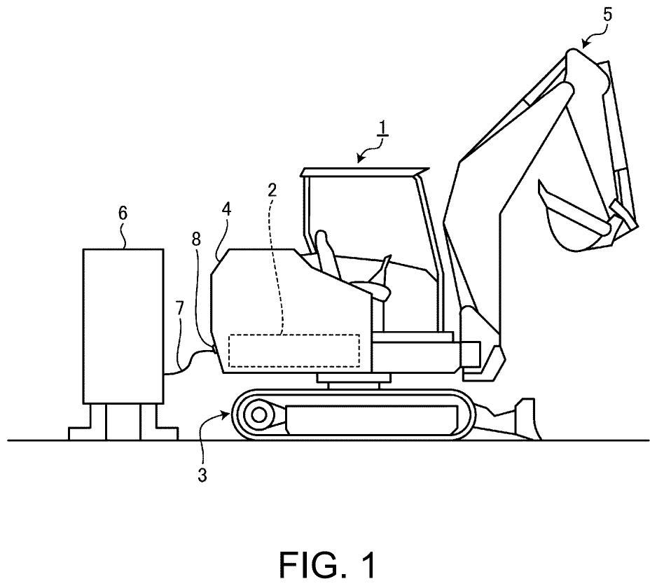

FIG. 1 is a diagram schematically illustrating a work machine 1 according to an embodiment. In the embodiment, the work machine 1 is an electric work machine that uses a battery 2 as a drive source. The battery 2 is mounted on the work machine 1. In the embodiment, the work machine 1 is an electric excavator. The work machine 1 includes a lower traveling body 3 including a crawler track, an upper rotating body 4 supported by the lower traveling body 3, and a work implement 5 supported by the upper rotating body 4. The work implement 5 includes a boom coupled to the upper rotating body 4, an arm coupled to the boom, and a bucket coupled to the arm.

The battery 2 includes a secondary battery. At a work site of the work machine 1, the battery 2 is charged by a charging device 6. In the embodiment, the battery 2 includes a rechargeable lithium ion battery. The charging device 6 is connected to the work machine 1 via a cable 7. The work machine 1 is provided with a charging port 8. The cable 7 is attached to and detached from the charging port 8. The power output from the charging device 6 is input to the battery 2 via the cable 7 and the charging port 8. The battery 2 is charged by the power output from the charging device 6.

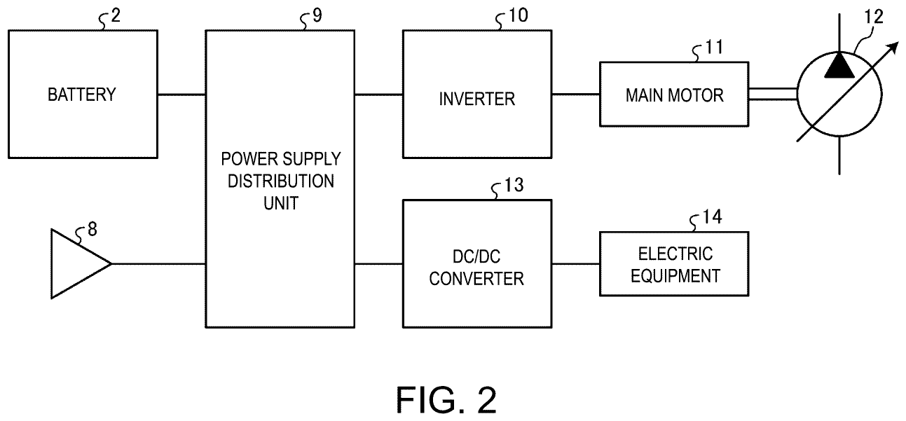

FIG. 2 is a block diagram illustrating the work machine 1 according to the embodiment. The work machine 1 includes the battery 2, the charging port 8, a power supply distribution unit 9, an inverter 10, a main motor 11, a hydraulic pump 12, a DC/DC converter 13, and electric equipment 14.

The power supply distribution unit 9 (PDU) distributes power from the battery 2. The inverter 10 supplies power from the power supply distribution unit 9 to the main motor 11. The inverter 10 converts DC voltage output from the power supply distribution unit 9 into AC voltage and outputs the AC voltage to the main motor 11. The main motor 11 is an electric motor. The main motor 11 is driven by the power from the inverter 10. The hydraulic pump 12 is driven by the main motor 11. The hydraulic pump 12 discharges hydraulic oil. The hydraulic oil discharged from the hydraulic pump 12 is supplied to a hydraulic actuator of the work machine 1. The hydraulic actuator of the work machine 1 includes a travel hydraulic motor that rotates the crawler track of the lower traveling body 3, a rotation hydraulic motor that rotates the upper rotating body 4, and a hydraulic cylinder that operates the work implement 5.

The DC/DC converter 13 converts the voltage of the battery 2 output from the power supply distribution unit 9 into a predetermined voltage. In the embodiment, the DC/DC converter 13 steps down the voltage of the battery 2 at a predetermined step-down ratio. The electric equipment 14 is driven using the power output from the DC/DC converter 13. The electric equipment 14 includes an auxiliary machine. An example of the electric equipment 14 includes an electric fan that generates airflow for cooling the main motor 11. Note that the electric equipment 14 may include a monitor disposed in a driver cab of the work machine 1.

The monitor displays detection data of a plurality of sensors provided to the work machine 1 and displays a monitoring result of a state of the work machine 1.

### Control System

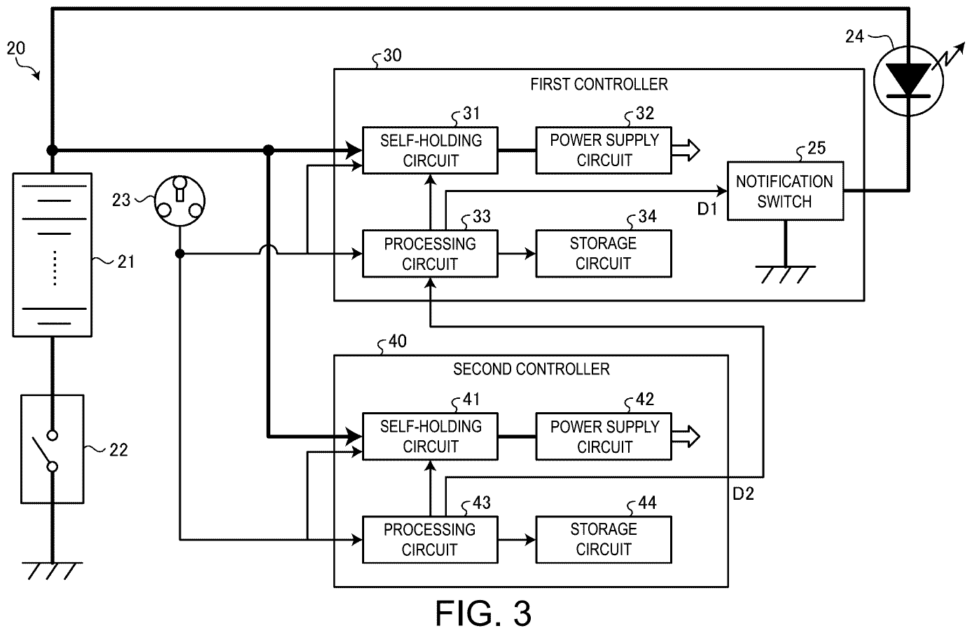

FIG. 3 is a block diagram illustrating a control system 20 of the work machine 1 according to the embodiment. The control system 20 includes a battery 21, a cutoff switch 22, a key switch 23, a notification device 24, a first controller 30 including a notification switch 25, and a second controller 40. The electric equipment 14 illustrated in FIG. 2 includes the notification device 24, the first controller 30, and the second controller 40.

The battery 21 supplies power to each of the notification device 24, the first controller 30, and the second controller 40. The battery 21 may be the battery 2 illustrated in FIG. 2. The battery 21 may be a lead battery having a rated voltage lower than a rated voltage of the battery 2.

The cutoff switch 22 cuts off the power supply from the battery 21 to each of the notification device 24, the first controller 30, and the second controller 40. The cutoff switch 22 is disposed between a negative electrode of the battery 2 and a ground. One end portion of the cutoff switch 22 is connected to the negative electrode of the battery 2. The other end portion of the cutoff switch 22 is connected to the ground. The cutoff switch 22 is operated by an operator of the work machine 1.

The key switch 23 is operated by the operator so as to be in any one of a key-off state, a key-on state, and a key-start state. When the operator rotates a key inserted into a key cylinder, the key switch 23 rotates to any position of “Off”, “On”, and “Start”. When the key is rotated to the “Off” position, the key switch 23 is in the key-off state. When the key is rotated to the “On” position, the key switch 23 is in the key-on state. When the key is rotated to the “Start” position, the key switch 23 is in the key-start state.

The key switch 23 outputs key signals to each of the first controller 30 and the second controller 40. The key signals output from the key switch 23 include a key-off signal output in the key-off state, a key-on signal output in the key-on state, and a key-start signal output in the key-start state.

When the key switch 23 is in the key-off state, power is not supplied to each of the notification device 24, the first controller 30, and the second controller 40. When the key switch 23 is in the key-off state, the main motor 11 is not driven. When the key switch 23 is in the key-on state, power is supplied to each of the notification device 24, the first controller 30, and the second controller 40. When the key switch 23 is in the key-on state, the main motor 11 cannot start driving. When the key switch 23 is in the key-start state, power is supplied to each of the notification device 24, the first controller 30, and the second controller 40. When the key switch 23 is in the key-start state, the main motor 11 starts driving.

Even in a case where the work machine 1 is in the key-off state, when the stopped period of the work machine 1 is prolonged, there is a possibility that the battery 21 over-discharges (battery died) due to dark current flowing from the battery 21 to the first controller 30 and the second controller 40. In a case where the work machine 1 is to be stopped for a long period of time, the operator operates the cutoff switch 22, causing the dark current to no longer flow from the battery 21 to the first controller 30 and the second controller 40. The dark current no longer flows from the battery 21 to the first controller 30 and the second controller 40, suppressing over-discharge of the battery 21.

The notification device 24 is interlocked with the first controller 30. The notification device 24 is connected to the first controller 30. The notification device 24 is not connected to the second controller 40. The notification device 24 is connected to the notification switch 25 of the first controller 30. The notification device 24 issues a notification that the first controller 30 is in operation. When the first controller 30 is in operation, the notification device 24 operates in a first state. The notification device 24 changes from the first state to a second state in response to ending of shutdown processing by the first controller 30. In response to the ending of the shutdown processing by the first controller 30, the first controller 30 shuts down. When the first controller 30 shuts down, the notification device 24 changes from the first state to the second state. In the embodiment, the notification device 24 is a light-emitting device including a light-emitting diode (LED). In the following description, the notification device 24 is referred to as a light-emitting device 24 as appropriate.

The light-emitting device 24 lights up using power supplied from the battery 21. In the embodiment, the light-emitting device 24 being in the first state also means the light-emitting device 24 being in a lit state. The light-emitting device 24 being in the second state also means the light-emitting device 24 being in an unlit state. When the first controller 30 is in operation, the light-emitting device 24 is in the lit state. When the first controller 30 shuts down, the notification device 24 changes from a lit state to an unlit state.

The notification switch 25 is connected to the light-emitting device 24. The notification switch 25 is provided between the light-emitting device 24 and the ground. One end portion of the notification switch 25 is connected to the light-emitting device 24. The other end portion of the notification switch 25 is connected to the ground. By actuation of the notification switch 25, the notification device 24 changes between the lit state and the unlit state.

The first controller 30 controls a first element of the work machine 1. The first controller 30 operates using power supplied from the battery 21. As an example, the first element is the power supply distribution unit 9. The first controller 30 is an electric controller for controlling the power supply distribution unit 9. The first controller 30 is connected to the light-emitting device 24. The first controller 30 and the light-emitting device 24 are interlocked with each other. The first controller 30 has a notification function of interlocking the light-emitting device 24.

The second controller 40 controls a second element of the work machine 1. The second controller 40 operates using power supplied from the battery 21. As an example, the second element is the inverter 10. The second controller 40 is an inverter controller that controls the inverter 10. Note that the second controller 40 may control the DC/DC converter 13 or may control a monitor disposed in the driver cab of the work machine 1. The second controller 40 is not connected to the light-emitting device 24. The second controller 40 and the light-emitting device 24 are not interlocked with each other. The second controller 40 does not have a notification function.

The first controller 30, the second controller 40, and the light-emitting device 24 are connected in parallel to the battery 21. Power from the battery 21 is supplied to the first controller 30, the second controller 40, and the light-emitting device 24.

The first controller 30 and the second controller 40 are connected in parallel to the key switch 23. Key signals from the key switch 23 are simultaneously input to the first controller 30 and the second controller 40. The first controller 30 and the second controller 40 are activated on the basis of the key-on signal from the one key switch 23. The first controller 30 and the second controller 40 simultaneously start the shutdown processing on the basis of the key-off signal from the one key switch 23.

The first controller 30 includes a self-holding circuit 31, a power supply circuit 32, a processing circuit 33, and a storage circuit 34.

The self-holding circuit 31 is connected to each of the battery 21 and the key switch 23. The self-holding circuit 31 receives key signals from the key switch 23. The self-holding circuit 31 includes an internal switch.

The power supply circuit 32 supplies the power supplied from the battery 21 via the self-holding circuit 31 to components of the first controller 30. The components of the first controller 30 include the processing circuit 33 and the storage circuit 34. When the internal switch of the self-holding circuit 31 is on, the power from the battery 21 is supplied to the power supply circuit 32 via the self-holding circuit 31. The power supply circuit 32 converts the voltage of the battery 21 into a predetermined voltage and supplies power to the components of the first controller 30. When the internal switch of the self-holding circuit 31 is off, the power from the battery 21 is not supplied to the power supply circuit 32, and the first controller 30 shuts down.

The processing circuit 33 includes a processor such as a central processing unit (CPU). The processing circuit 33 is connected to the key switch 23. The processing circuit 33 receives key signals from the key switch 23.

The storage circuit 34 includes a nonvolatile memory such as a read only memory (ROM) and an electrically erasable and programmable read only memory (EEPROM), and a volatile memory such as a random access memory (RAM).

Upon receiving the key-on signal from the key switch 23 by the self-holding circuit 31, the internal switch of the self-holding circuit 31 is turned on. Upon turning on the internal switch of the self-holding circuit 31, the power from the battery 21 is supplied to each of the processing circuit 33 and the storage circuit 34 via the self-holding circuit 31 and the power supply circuit 32. By power being supplied to each of the processing circuit 33 and the storage circuit 34, each of the processing circuit 33 and the storage circuit 34 is activated. Upon activating each of the processing circuit 33 and the storage circuit 34, a computer program stored in the nonvolatile memory of the storage circuit 34 is read into the processing circuit 33, and control of the first controller 30 is started.

Upon receiving the key-off signal from the key switch 23 by the processing circuit 33, the shutdown processing by the first controller 30 is started. Examples of the shutdown processing by the first controller 30 include transfer processing of transferring data held in the volatile memory (RAM) of the storage circuit 34 to the nonvolatile memory (EEPROM). Examples of the data held in the nonvolatile memory include an operation time of the work machine 1, a load frequency of the hydraulic pump 12, and a failure history of the work machine 1. The processing circuit 33 transmits an operation signal D1 indicating that the processing circuit 33 is in operation, to the self-holding circuit 31 during execution of the shutdown processing.

When the self-holding circuit 31 receives the operation signal D1 from the processing circuit 33, the internal switch of the self-holding circuit 31 maintains the on state even if the self-holding circuit 31 receives the key-off signal from the key switch 23. That is, even if the self-holding circuit 31 receives the key-off signal, the internal switch of the self-holding circuit 31 is not turned off until the shutdown processing by the first controller 30 ends. When the shutdown processing by the first controller 30 ends, output of the operation signal D1 from the processing circuit 33 to the self-holding circuit 31 is stopped, and the internal switch of the self-holding circuit 31 is turned off. When the internal switch of the self-holding circuit 31 is turned off, the first controller 30 shuts down. In the embodiment, the ending of the shutdown processing by the first controller 30 means that the first controller 30 shuts down.

The first controller 30 includes the notification switch 25. The notification switch 25 is controlled by the processing circuit 33. The processing circuit 33 transmits the operation signal D1 indicating that the processing circuit 33 is in operation, to the notification switch 25 during execution of the shutdown processing. When the notification switch 25 receives the operation signal D1 from the processing circuit 33, the notification switch 25 maintains the on state. Even if the key-off signal is output from the key switch 23, the notification switch 25 is not turned off until the shutdown processing by the first controller 30 ends. When the notification switch 25 is on, power is supplied from the battery 21 to the light-emitting device 24, and the light-emitting device 24 changes to the lit state. When the shutdown processing by the first controller 30 ends, output of the operation signal D1 from the processing circuit 33 to the notification switch 25 is stopped, and the notification switch 25 is turned off. By the notification switch 25 being turned off, the light-emitting device 24 changes from the lit state to the unlit state. In the embodiment, the light-emitting device 24 changes from the lit state to the unlit state at the same time as the shutdown of the first controller 30.

The second controller 40 includes a self-holding circuit 41, a power supply circuit 42, a processing circuit 43, and a storage circuit 44.

The self-holding circuit 41 has the same function as that of the self-holding circuit 31. The self-holding circuit 41 is connected to each of the battery 21 and the key switch 23. The self-holding circuit 41 includes an internal switch. The power supply circuit 42 has the same function as that of the power supply circuit 32. When the internal switch of the self-holding circuit 41 is on, power from the battery 21 is supplied to each of the processing circuit 43 and the storage circuit 44 via the self-holding circuit 41 and the power supply circuit 42. When the internal switch of the self-holding circuit 41 is off, power from the battery 21 is not supplied to the power supply circuit 42, and the second controller 40 shuts down. The processing circuit 43 has the same function as that of the processing circuit 33. The processing circuit 43 is connected to the key switch 23. The storage circuit 44 has the same function as that of the storage circuit 34.

Upon receiving the key-on signal from the key switch 23 by the self-holding circuit 41, the control of the second controller 40 is started. Upon receiving the key-off signal from the key switch 23 by the processing circuit 43, the shutdown processing by the second controller 40 is started. The processing circuit 43 transmits an operation signal D2 indicating that the processing circuit 43 is in operation, to the self-holding circuit 41 during execution of the shutdown processing.

As with the first controller 30, even if the self-holding circuit 41 receives the key-off signal, the internal switch of the self-holding circuit 41 is not turned off until the shutdown processing by the second controller 40 ends. When the shutdown processing by the second controller 40 ends, output of the operation signal D2 from the processing circuit 43 to the self-holding circuit 41 is stopped, and the internal switch of the self-holding circuit 41 is turned off. By the internal switch of the self-holding circuit 41 being turned off, the second controller 40 shuts down. In the embodiment, the ending of the shutdown processing by the second controller 40 means that the second controller 40 shuts down.

The second controller 40 does not include the notification switch 25. The processing circuit 43 transmits the operation signal D2 indicating that the processing circuit 43 is in operation, to the first controller 30 during execution of the shutdown processing. When the operation signal D2 from the processing circuit 43 is received by the processing circuit 33 of the first controller 30, the processing circuit 33 does not shut down the first controller 30 until the second controller 40 ends the shutdown processing. When the shutdown processing by the second controller 40 ends, output of the operation signal D2 from the processing circuit 43 to the first controller 30 is stopped. When the output of the operation signal D2 from the processing circuit 43 is stopped, the processing circuit 33 determines that the shutdown processing by the second controller 40 has ended. The processing circuit 33 of the first controller 30, upon determination that the second controller 40 has ended the shutdown processing, ends the shutdown processing by the first controller 30.

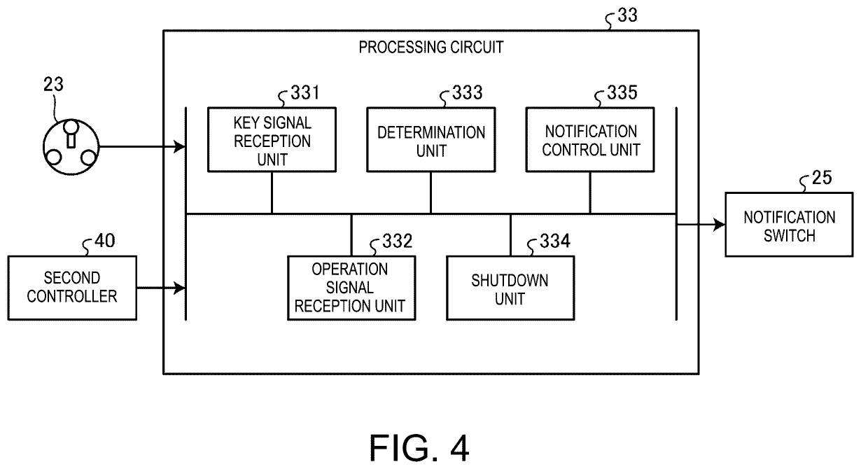

FIG. 4 is a functional block diagram illustrating the processing circuit 33 of the first controller 30 according to the embodiment. As illustrated in FIG. 4, the processing circuit 33 includes a key signal reception unit 331, an operation signal reception unit 332, a determination unit 333, a shutdown unit 334, and a notification control unit 335.

The key signal reception unit 331 receives key signals from the key switch 23. The key signals include a key-off signal, a key-on signal, and a key-start signal.

The operation signal reception unit 332 receives the operation signal D2 from the second controller 40. The second controller 40 outputs the operation signal D2 indicating that the second controller 40 is in operation, to the first controller 30 during execution of the shutdown processing by the second controller 40. The operation signal reception unit 332 receives the operation signal D2 from the second controller 40 while the second controller 40 is executing the shutdown processing.

The determination unit 333 determines whether the shutdown processing by the second controller 40 has ended, on the basis of the reception state of the operation signal D2 by the operation signal reception unit 332. As described above, while the second controller 40 is executing the shutdown processing, the operation signal D2 is output from the second controller 40 to the first controller 30. When the shutdown processing by the second controller 40 ends, the output of the operation signal D2 from the second controller 40 to the first controller 30 is stopped. The determination unit 333 can determine that the second controller 40 is executing the shutdown processing, when the operation signal reception unit 332 is receiving the operation signal D2. The determination unit 333 can determine that the shutdown processing by the second controller 40 has ended, when the operation signal reception unit 332 no longer receives the operation signal D2.

When the determination unit 333 determines that the shutdown processing by the second controller 40 has ended, the shutdown unit 334 ends the shutdown processing by the first controller 30.

When the shutdown processing by the first controller 30 is ended, the notification control unit 335 controls the notification switch 25 so that the light-emitting device 24 changes from the lit state to the unlit state. In the embodiment, when the shutdown processing by the first controller 30 ends, the notification control unit 335 stops the output of the operation signal D1 to the notification switch 25 and turns off the notification switch 25. By the notification switch 25 being turned off, the light-emitting device 24 changes from the lit state to the unlit state.

### Control Method

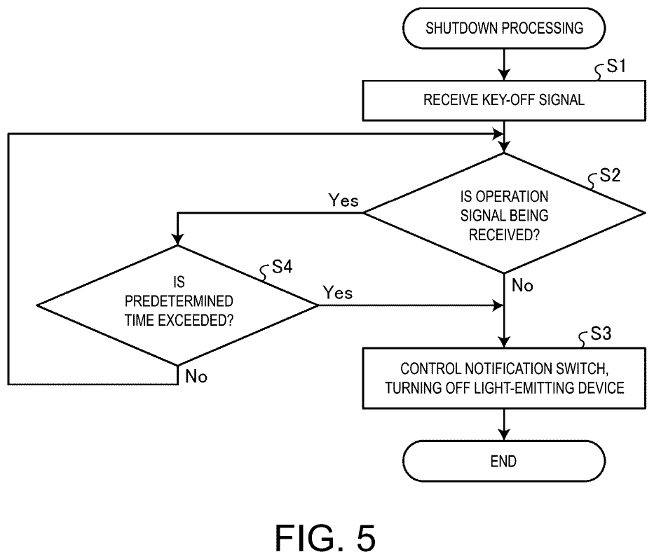

FIG. 5 is a flowchart illustrating a control method of the work machine 1 according to the embodiment. FIG. 5 is a flowchart illustrating the operation of the first controller 30 when the key switch 23 is set to the key-off state.

When the key switch 23 is set to the key-off state, the key-off signal is simultaneously input to the first controller 30 and the second controller 40. The key signal reception unit 331 of the first controller 30 receives the key-off signal from the key switch 23 (step S1).

The first controller 30 starts the shutdown processing on the basis of the key-off signal from the key switch 23. The second controller 40 also starts the shutdown processing on the basis of the key-off signal from the key switch 23.

During execution of the shutdown processing by the first controller 30, the operation signal D1 is transmitted from the processing circuit 33 to the notification switch 25. The notification switch 25 is turned on on the basis of the operation signal D1. When the notification switch 25 is turned on, the light-emitting device 24 is brought to the lit state.

During execution of the shutdown processing by the second controller 40, the operation signal D2 is transmitted from the second controller 40 to the first controller 30. The operation signal reception unit 332 of the first controller 30 receives the operation signal D2 from the second controller 40. On the other hand, when the shutdown processing by the second controller 40 ends, the transmission of the operation signal D2 from the second controller 40 to the first controller 30 is stopped. The operation signal reception unit 332 of the first controller 30 does not receive the operation signal D2 from the second controller 40.

The determination unit 333 of the first controller 30 determines whether the operation signal reception unit 332 is receiving the operation signal D2 of the second controller 40 (step S2).

In step S2, upon determination that the operation signal reception unit 332 is no longer receiving the operation signal D2 of the second controller 40 (step S2: No), the determination unit 333 determines that the shutdown processing by the second controller 40 has ended. When the shutdown processing by the first controller 30 is ended, the notification control unit 335 controls the notification switch 25, so that the light-emitting device 24 changes from the lit state to the unlit state (step S3). Upon determination that the second controller 40 has ended the shutdown processing, the shutdown unit 334 of the first controller 30 ends the shutdown processing by the first controller 30.

When the determination is made that the operation signal reception unit 332 is receiving the operation signal D2 of the second controller 40 in step S2 (step S2: Yes), the shutdown unit 334 determines whether the time from the time point of receipt of the key-off signal by the key signal reception unit 331 in step S1 exceeds a predetermined time (step S4).

When the determination is made that the time from the time point of receipt of the key-off signal by the key signal reception unit 331 has not exceeded the predetermined time in step S4 (step S4: No), the processing returns to step S2.

When the determination is made that the time from the time point of receipt of the key-off signal by the key signal reception unit 331 exceeds the predetermined time in step S4 (step S4: Yes), the notification control unit 335 controls the notification switch 25 so that the light-emitting device 24 changes from the lit state to the unlit state (step S3), and the shutdown unit 334 ends the shutdown processing of the first controller 30.

### Effects

As described above, the work machine 1 includes the first controller 30 configured to start the shutdown processing on the basis of the key-off signal from the key switch 23, the second controller 40 configured to start the shutdown processing on the basis of the key-off signal from the key switch 23, and the light-emitting device 24 configured to change from the lit state to the unlit state in response to the ending of the shutdown processing by the first controller 30. The first controller 30 ends the shutdown processing upon determination that the second controller 40 has ended the shutdown processing.

According to the embodiment, the first controller 30 has a notification function of interlocking the light-emitting device 24. Since the light-emitting device 24 is interlocked with the first controller 30, the first controller 30 can cause the light-emitting device 24 to issue notifications that the first controller 30 is in operation and that the first controller 30 shut down. The second controller 40 does not have the notification function. Since the light-emitting device 24 is not interlocked with the second controller 40, the second controller 40 cannot cause the light-emitting device 24 to issue notifications that the second controller 40 is in operation and that the second controller 40 shut down. In a case where the first controller 30 interlocked with the light-emitting device 24 and the second controller 40 not interlocked with the light-emitting device 24 are mounted on the work machine 1, the shutdown processing by the first controller 30 is ended after the shutdown processing by the second controller 40 ends, and the light-emitting device 24 is brought to the unlit state at the same time that the shutdown processing by the first controller 30 ends. Accordingly, even when the light-emitting device 24 is interlocked with the first controller 30 and not interlocked with the second controller 40, the operator can recognize whether both the first controller 30 and the second controller 40 have ended the shutdown processing, by checking the light-emitting device 24. The operator can operate the cutoff switch 22 after both of the first controller 30 and the second controller 40 shut down. Thus, operation of the cutoff switch 22 is suppressed during operation of at least one of the first controller 30 and the second controller 40. That is, even if the second controller 40 does not have the notification function, it is possible to prevent the operator from forcibly cutting off the power supply from the battery 21 to the second controller 40 during operation of the second controller 40, on the basis of the notification function of the first controller 30. Therefore, failure of the first controller 30 and the second controller 40 is suppressed.

The second controller 40 outputs the operation signal D2 indicating that the second controller 40 is in operation, to the first controller 30 during execution of the shutdown processing. The second controller 40 stops outputting the operation signal D2 in response to the ending of the shutdown processing by the second controller 40. Thus, the first controller 30 can determine whether the shutdown processing by the second controller 40 has ended, on the basis of the operation signal D2 from the second controller 40.

In the first controller 30, the processing circuit 33 controls the notification switch 25 so that the light-emitting device 24 changes from the lit state to the unlit state when the shutdown processing by the first controller 30 ends. The operator can recognize whether each of the first controller 30 and the second controller 40 is in operation, by checking the light-emitting device 24. The operator does not operate the cutoff switch 22 while each of the first controller 30 and the second controller 40 is in operation, but can operate the cutoff switch 22 after each of the first controller 30 and the second controller 40 shuts down. Since the operation of the cutoff switch 22 is suppressed during the operation of each of the first controller 30 and the second controller 40, failure of each of the first controller 30 and the second controller 40 is suppressed.

Even when the operation signal reception unit 332 is receiving the operation signal D2 of the second controller 40, the shutdown unit 334 ends the shutdown processing by the first controller 30 when the time from the time point of receipt of the key-off signal exceeds a predetermined time, and the notification control unit 335 changes the light-emitting device 24 from the lit state to the unlit state. After the key switch 23 is operated to the key-off state, there is a possibility that the second controller 40 cannot be shut down due to freezing of the second controller 40, for example. When the operation signal D2 continues to be output from the second controller 40 to the first controller 30 for a predetermined time or longer, for example, due to the freezing of the second controller 40, the first controller 30 is shut down and the light-emitting device 24 is turned off. Even when the second controller 40 freezes, the operator can operate the cutoff switch 22 after checking that the first controller 30 is shut down and the light-emitting device 24 is turned off.

### Other Embodiments

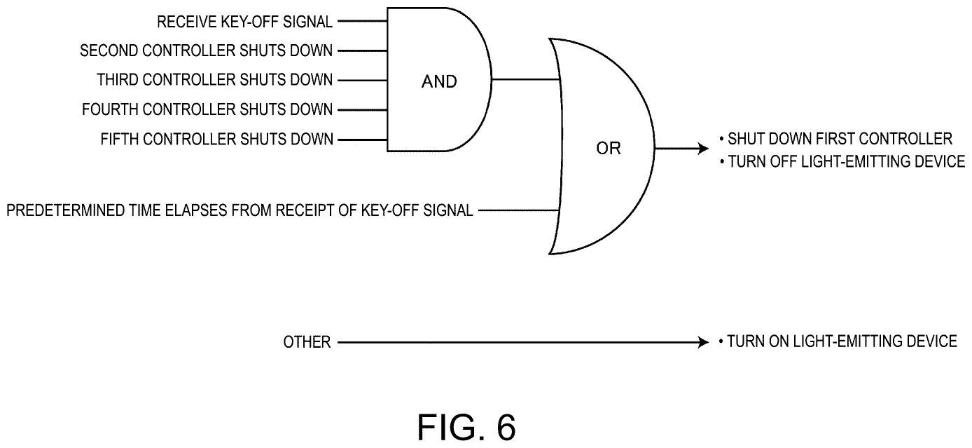

FIG. 6 is a diagram illustrating a control method of the work machine 1 according to another embodiment. In the embodiment described above, the controller not interlocked with the light-emitting device 24 is the second controller 40. A plurality of controllers not interlocked with the light-emitting device 24 may be mounted on the work machine 1. As illustrated in FIG. 6, a second controller, a third controller, a fourth controller, and a fifth controller not interlocked with the light-emitting device 24 may be mounted on the work machine 1. The first controller 30 receives the key-off signal and, after the shutdown processing by all of the controllers from the second controller to the fifth controller ends, ends the shutdown processing by the first controller 30. In the example illustrated in FIG. 6 as well, the shutdown unit 334 of the first controller 30 may end the shutdown processing by the first controller 30 when the time from the time point of receipt of the key-off signal exceeds a predetermined time even if the operation signal reception unit 332 is receiving the operation signal D2 from at least one of the second controller to the fifth controller.

In the embodiment described above, the processing circuit 43 of the second controller 40 transmits the operation signal D2 indicating that the processing circuit 43 is in operation to the first controller 30 during execution of the shutdown processing, and on the basis of the reception state of the operation signal D2, the first controller 30 determines whether the shutdown processing by the second controller 40 has ended. In a case where the first controller 30 and the second controller 40 communicate with each other by a controller area network (CAN), which is a type of communication protocol, the first controller 30 may monitor the CAN communication of the second controller 40 and, on the basis of a result of the monitoring, determine whether the shutdown processing by the second controller 40 has ended.

In the embodiment described above, the first controller 30 includes the notification switch 25. The notification switch 25 may be disposed outside the first controller 30.

In the embodiment described above, the notification device 24 is a light-emitting device. The notification device 24 may be a sound output device or a display device. In a case where the notification device 24 is a sound output device, the sound output device may change from a state of outputting sound to a state of not outputting sound in response to the ending of the shutdown processing by the first controller 30. When the notification device 24 is a display device, the display device may change from a state of displaying display data to a state of not displaying display data in response to the ending of the shutdown processing by the first controller 30.

In the embodiment described above, the work machine 1 is an electric excavator. The work machine 1 may be, for example, an electric forklift.

In the embodiment described above, the drive source of the work machine 1 is the main motor 11. That is, the work machine 1 is an electric work machine. The drive source of the work machine 1 may be an engine. The first controller 30 may be, for example, an engine controller that controls an amount of fuel injected into a combustion chamber of the engine.

In the embodiment described above, at least one of the cutoff switch 22 and the key switch 23 may be operated by a maintenance person of the work machine 1.

### Reference Signs List

1 Work machine, 2 Battery, 3 Lower traveling body, 4 Upper rotating body, 5 Work implement, 6 Charging device, 7 Cable, 8 Charging port, 9 Power supply distribution unit, 10 Inverter, 11 Main motor, 12 Hydraulic pump, 13 DC/DC converter, 14 Electric equipment, 20 Control system, 21 Battery, 22 Cutoff switch, 23 Key switch, 24 Light-emitting device (notification device), 25 Notification switch, 30 First controller, 31 Self-holding circuit, 32 Power supply circuit, 33 Processing circuit, 34 Storage circuit, 40 Second controller, 41 Self-holding circuit, 42 Power supply circuit, 43 Processing circuit, 44 Storage circuit, 331 Key signal reception unit, 332 Operation signal reception unit, 333 Determination unit, 334 Shutdown unit, 335 Notification control unit

1. A control system for a work machine, comprising:
a first controller configured to start shutdown processing on the basis of a key-off signal from a key switch;
a second controller configured to start shutdown processing on the basis of the key-off signal; and
a notification device configured to change from a first state to a second state in response to ending of the shutdown processing by the first controller, wherein
the first controller is configured to end the shutdown processing after determination that the second controller has ended the shutdown processing.

2. The control system for a work machine, according to claim 1, wherein
the second controller is configured to output an operation signal indicating that the second controller is in operation, during execution of the shutdown processing, and
the first controller is configured to:
receive the key-off signal from the key switch,
receive the operation signal from the second controller,
determine whether the shutdown processing by the second controller has ended, on the basis of a reception state of the operation signal, and
end the shutdown processing by the first controller upon determination that the shutdown processing by the second controller has ended.

3. The control system for a work machine, according to claim 2, wherein
the first controller includes
a notification switch connected to the notification device, and
a notification controller configured to control the notification switch such that the notification device changes from the first state to the second state, when the shutdown processing by the first controller is ended.

4. The control system for a work machine, according to claim 2, wherein
the first controller is configured to determine that the shutdown processing by the second controller has ended, when the first controller no longer receives the operation signal,
the key-off signal is simultaneously input to the first controller and the second controller, and
the first controller is configured to end the shutdown processing by the first controller when a time from a time point of receipt of the key-off signal exceeds a predetermined time, even while the first controller is receiving the operation signal.

5. A work machine comprising:
the control system for a work machine, according to claim 1.

6. A control method for a work machine, the method comprising:
starting, by a first controller, shutdown processing on the basis of a key-off signal from a key switch;
starting, by a second controller, shutdown processing in response to the key-off signal; and
causing a notification device to change from a first state to a second state in response to ending of the shutdown processing by the first controller, wherein
the first controller is configured to end the shutdown processing after determination that the second controller has ended the shutdown processing.
